(19) United States
(12) Patent Application Publication
(10) Pub. No.: US 2026/0139711 A1
(43) Pub. Date: May 21, 2026

(54) CONNECTOR FOR DYNAMIC ENERGY TRANSFER SYSTEM

(71) Applicant: Caterpillar Inc., Peoria, IL (US)

(72) Inventors: Ian A. TIGGEMANN, Peoria, IL (US); Antony Stephen Paul VINCENT, Chennai (IN)

(73) Assignee: Caterpillar Inc., Peoria, IL (US)

(21) Appl. No.: 18/949,484

(22) Filed: Nov. 15, 2024

(51) Int. Cl. F16D 3/16; B60L 5/38

(52) U.S. Cl. CPC F16D 3/16; B60L 5/38

(57) ABSTRACT

A rotational mount assembly for connecting a contactor assembly to an arm assembly, including: a joint comprising a first connector and a second connector, the first connector being configured to connect to the arm assembly, where the first connector is configured to rotate about a first axis, the second connector is configured to rotate about a second axis, and the first axis is substantially perpendicular to the second axis; a joint bracket connected to the second connector of the joint, the joint bracket including a sleeve; and a contactor assembly bracket configured to connect to the contactor assembly, the contactor assembly bracket including a shaft, wherein the sleeve of the joint bracket surrounds the shaft of the contactor assembly bracket, the contactor assembly bracket is configured to rotate about a third axis, and the third axis is substantially perpendicular to the first axis and the second axis.

### TECHNICAL FIELD

The present disclosure relates generally to a connecter, and more particularly, to a connector between components of a dynamic energy transfer system, such as in a mobile machine.

### BACKGROUND

Mobile industrial machines, such as earth-moving or other mobile machines, may be of substantial weight and may bear immense loads, thus requiring a large amount of power. Internal combustion engines drive many industrial machines. However, internal combustion engines have drawbacks such as fuel costs, fuel transport difficulties, and release of detrimental engine emissions. Accordingly, there has been a movement toward powering large mobile industrial machines with all-electric or hybrid (e.g., a combination of electric and internal combustion engine) power systems.

One such electric power system is a dynamic energy transfer system. In the dynamic energy transfer systems, the machine receives power from an electricity-conducting rail system. An electricity-conducting connector assembly may include a contactor assembly with a number of conducting terminals, which connect the machine to the rail system. The contactor assembly connects to a boom via a connector. The connector allows the contactor assembly to maintain contact with the rail system even when the machine traverses uneven terrain.

US 2019/0210467 to Ohman et al. (“the '467 publication”) is directed to a current collector for mounting on a vehicle for transmission of electric power between a current conductor and the vehicle. The '467 publication discloses an embodiment in which a current collector arm is attached to the vehicle by a pivoting means. However, the '467 publication does not disclose a connector that effectively biases the current collector back to a central orientation. Further, the '467 publication does not disclose a connector that effectively aligns the current collector with the current conductor and maintains contact therebetween.

The methods and systems of the present disclosure may solve one or more of the problems set forth above or other problems in the art, including problems discussed below. The attached claims define the scope of the protection that the present disclosure provided, and the scope of protection is not dependent on the ability to solve any specific problem.

### SUMMARY

In one aspect, a rotational mount assembly for connecting a contactor assembly to an arm assembly comprises: a joint comprising a first connector and a second connector, the first connector being configured to connect to the arm assembly, wherein the first connector is configured to rotate about a first axis, the second connector is configured to rotate about a second axis, and the first axis is substantially perpendicular to the second axis; a joint bracket connected to the second connector of the joint, the joint bracket including a sleeve; and a contactor assembly bracket configured to connect to the contactor assembly, the contactor assembly bracket including a shaft, wherein the sleeve of the joint bracket surrounds the shaft of the contactor assembly bracket, the contactor assembly bracket is configured to rotate about a third axis, and the third axis is substantially perpendicular to the first axis and the second axis.

In another aspect, a mobile machine comprises: a frame; an arm connected to the frame; a contactor configured to receive electricity from a rail; and a rotational mount connecting the arm to the contactor, the rotational mount comprising: a joint comprising a first connector and a second connector, the first connector being connected to the arm, wherein the first connector is configured to rotate about a first axis, and the second connector is configured to rotate about a second axis; a joint bracket connected to the second connector of the joint, the joint bracket including a sleeve; and a contactor bracket connected to the contactor, the contactor bracket including a shaft, wherein the sleeve of the joint bracket surrounds the shaft of the contactor bracket, and the contactor bracket is configured to rotate about a third axis.

In another aspect, a mount assembly for connecting a rotating component to an arm comprises: a joint comprising a first connector and a second connector, the first connector being configured to connect to the arm, wherein the first connector is configured to rotate about a first axis, the second connector is configured to rotate about a second axis, and the first axis is substantially perpendicular to the second axis; a joint bracket connected to the second connector of the joint, the joint bracket including a sleeve; a component bracket configured to connect to the rotating component, the component bracket including a shaft, wherein the sleeve of the joint bracket surrounds the shaft of the component bracket, the component bracket is configured to rotate about a third axis, and the third axis is substantially perpendicular to the first axis and the second axis; and first and second springs, wherein the first spring allows but opposes rotation in a clockwise direction about the third axis, and the second spring allows but opposes rotation in a counterclockwise direction about the third axis.

In some instances, at least one bearing assembly is between the sleeve of the joint bracket and the shaft of the component bracket, wherein the at least one bearing assembly includes at least one tapered bearing.

### BRIEF DESCRIPTION OF THE DRAWINGS

The accompanying drawings, which the Specification incorporated such that the figures constitute a part of the Specification, illustrate various exemplary embodiments and together with the description, serve to explain the principles of the disclosed embodiments.

FIG. 1 is a perspective view of a mobile machine power system, which includes a mobile machine having an electricity-conducting connector assembly connected to a contactor assembly, and an electricity-conducting rail system, according to some embodiments.

FIG. 2 is a cross-sectional view of the contactor assembly contacting the electricity-conducting rail system of FIG. 1, according to some embodiments.

FIG. 3 is a perspective view of a rotational mount assembly between a boom assembly and the contactor assembly of the electricity-conducting connector assembly of FIG. 1, according to some embodiments.

FIG. 4 is a perspective view of a joint bracket and a contactor assembly bracket of the rotational mount assembly of FIG. 3, according to some embodiments.

FIG. 5 is a cross-sectional view of the joint bracket and the contactor assembly bracket of the rotational mount assembly of FIG. 4, according to some embodiments.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

As used herein, the term “proximal” locationally identifies components, parts, assemblies, or systems located closer to the frame/body of the mobile machine. Conversely, the term “distal” locationally identifies components, parts, assemblies, or systems located farther away from the frame/body of the mobile machine.

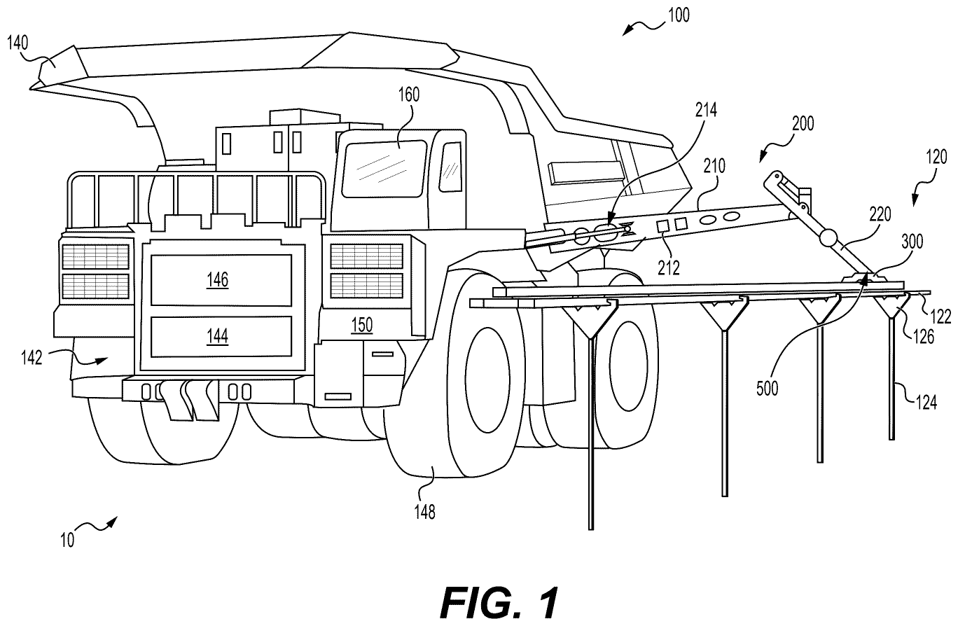

FIG. 1 is a perspective view of a mobile machine power system 100, which includes a mobile machine 140 connected to an electricity-conducting connector assembly 200 connected to a contactor assembly 300, and an electricity-conducting rail system 120, according to some embodiments. As FIG. 1 shows, the mobile machine 140 may include an electric drive system 142 having at least one electric motor 144 and at least one battery system 146. The electric drive system 142 may drive a set of ground-engaging elements 148, such as tires or continuous tracks, for propelling and maneuvering the mobile machine 140 across a ground surface 10. The mobile machine 140 also may include a frame/body 150, which supports mechanical components of the mobile machine 140, the mechanical components including the electricity-conducting connector assembly 200. The mobile machine 140 may include either an all-electric power system or a hybrid power system (e.g., a power system that include an electric power system and another system that is not an electric power system), and the electricity-conducting rail system 120 may power either system. A machine operator located in an operator cabin 160 may control the mobile machine 140 and its various systems, or the mobile machine 140 may be a semi-autonomous, fully-autonomous, or remotely-operated machine.

In some instances, the mobile machine 140 may be a free-steering machine, allowing the operator of the machine (or autonomous control system) to freely control the direction and route of the mobile machine 140. Thus, the mobile machine 140 may be configured to travel (e.g., in a free-steering manner) selectively along a work route or path within a job site, with the electricity-conducting rail system 120 positioned generally along the work route or path. FIG. 1 shows the mobile machine 140 in the context of a mining truck, which may transports ore or other materials in a mine environment. The present disclosure is not so limited, however, and the present disclosure encompasses other types of machines, including for example articulated trucks, asphalt pavers, backhoe loaders, drills, rope shovels, excavators, forest machines, hydraulic mining shovels, material handlers, motor graders, off-highway trucks, pipelayers, road reclaimers, telehandlers, track loaders, underground mining dump loaders and trucks, wheel loaders, wheel tractor-scrapers, or other machines.

The electricity-conducting rail system 120 may include elevated conductor rails 122, which connect to a power source (e.g., a power grid, generator, or energy storage devices, not shown). Ground-engaging support poles 124 may support the elevated conductor rails 122 as well as rail bracket assemblies 126. While FIG. 1 shows an example where the elevated conductor rails 122 include three (3) conductor rails, the elevated conductor rails 122 may include a greater or lesser number of rails. In some instances, two (2) of the elevated conductor rails 122 provide electrical power at different polarities (e.g., a conductor rail with a positive polarity, and a conductor rail with a negative polarity), while the third elevated conductor rail 122 provides a reference of 0 volts (e.g., a ground rail). The elevated conductor rails 122 may have a height, for example, in the range of about 8 to about 15 feet above the ground surface 10. In this example, the middle rail of the elevated conductor rails 122 is at a greater height than the two side rails of the elevated conductor rails 122. Thus, in some instances, the electricity-conducting rail system 120 does not form a pantograph-type overhead power system, nor an under-machine or low-ground-located power system.

The electricity-conducting connector assembly 200 may electrically connect the mobile machine 140 to the electricity-conducting rail system 120. The electricity-conducting connector assembly 200 may include a boom assembly 210 having a proximal end and a distal end; and an arm assembly, such as a trailing arm assembly 220, having a proximal end connected to the distal end of the boom assembly 210. As shown in FIG. 1, the contactor assembly 300 may be connected to a distal end of the trailing arm assembly 220, by a rotational mount assembly 500, as further described herein. As used herein, the term “trailing” refers to a direction opposite the forward direction of travel of the mobile machine 140. The boom assembly 210 may house or otherwise include a hydraulic system 212 for pivotably extending, retracting, and locking the boom assembly 210, as well as a pneumatic system 214 for generating and controlling fluid pressure of downstream components (e.g., the trailing arm assembly 220 and the contactor assembly 300), and an integrated busbar (not shown) for transferring electrical energy along a length of the boom assembly 210. In some instances, the pneumatic system 214 may be a hydraulic system. In some instances, the hydraulic system 212 may be a pneumatic system.

As FIG. 1 shows, the boom assembly 210 may extend generally horizontally from a side of the mobile machine, and connect to a side of the frame/body 150 of the mobile machine 140 about a pivot joint (or other relative movement enabling joint configured to enable relative movement between mobile machine 140 and boom assembly 210). The pivot joint may be located at a height of approximately over 8 feet on the machine (above the ground surface 10), or otherwise at a height equal to or above the electricity-conducting rail system 120. The electricity-conducting connector assembly 200 may include several different states of deployment, including an extended state in which the boom assembly 210 is extended generally horizontally outward away from a side of the mobile machine 140 (as shown in FIG. 1), a retracted state (not shown) in which the boom assembly 210 is rotated or pivoted inward to rest against the frame/body 150 of the mobile machine 140 (not shown), and a locked state in which the boom assembly is locked to the side of the frame/body 150 of the mobile machine 140 in the retracted state by a hydraulically-actuated locking pin (not shown). The boom assembly 210 may be engaged or disengaged from the electricity-conducting rail system 120 by the operator, remotely, or autonomously via an engagement or disengagement procedure, or automatically by the mobile machine 140. While the boom assembly 210 is shown attached to a mining truck, in some instances the boom assembly 210 is coupled to various types of mobile machines 140 by an interchangeable adapter (not shown) that is specific to the type of machine.

The trailing arm assembly 220 may form a mechanical connection as well as an electrical connection between the boom assembly 210 and the contactor assembly 300, and may include one or more arms. The one or more arms may be extendable and retractable (e.g., pneumatically, hydraulically, or mechanically) and may have multiple degrees of freedom to allow for vertical and lateral pivoting about the boom assembly 210.

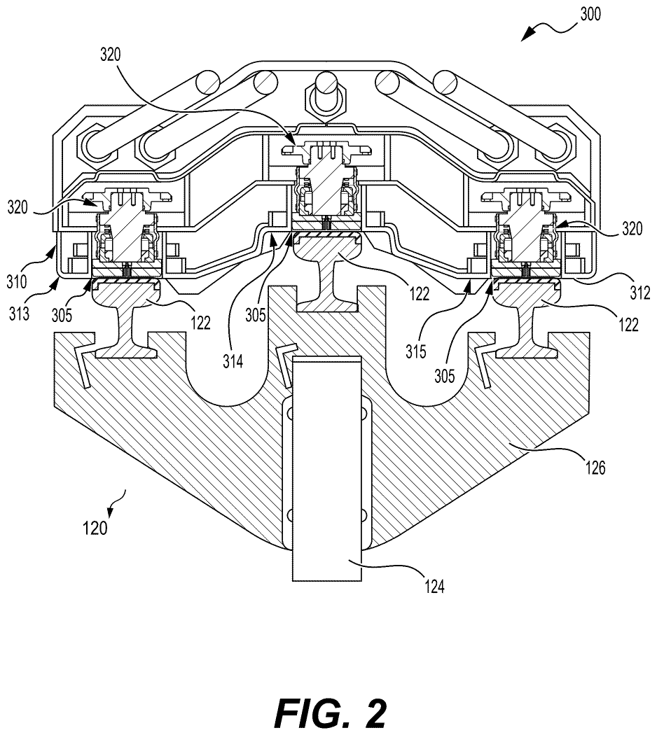

FIG. 2 is a cross-sectional view of the contactor assembly 300 contacting the electricity-conducting rail system 120, according to some embodiments. As FIG. 2 illustrates, the contactor assembly 300 may interface with the electricity-conducting rail system 120. The contactor assembly 300 may include a base 310 and a plurality of conducting terminals 320. Each of the conducting terminals 320 may electrically connect to a busbar (not shown) within the contactor assembly 300. A bottom surface 312 of the base 310 may include a plurality of openings 305. To provide power to the mobile machine 140 through the contactor assembly 300, a portion of each of the conducting terminals 320 may be extended through or flush with one of the plurality of openings 305 in the bottom surface 312 of the base 310, such that the conducting terminals 320 slide along the elevated conductor rails 122 to collect electrical energy. In some instances, the conducting terminals 320 may reside in a three-by-three matrix, such that there are three groups of linearly-aligned conducting terminals 320, with each group located in a first side region 313, a second side region 315, and a central region 314 of the base portion 402, respectively. However, the contactor assembly 300 may include a greater or fewer number of conducting terminals 320, such as for example three, six, or twelve conducting terminals 320, and may, for example, be arranged in a different manner. Although FIG. 2 shows the contactor assembly 300 having a top surface with a stepped or raised central section, the top surface may have different surfaces or contours (such as a generally flat top surface), to which the rotational mount assembly 500 connects.

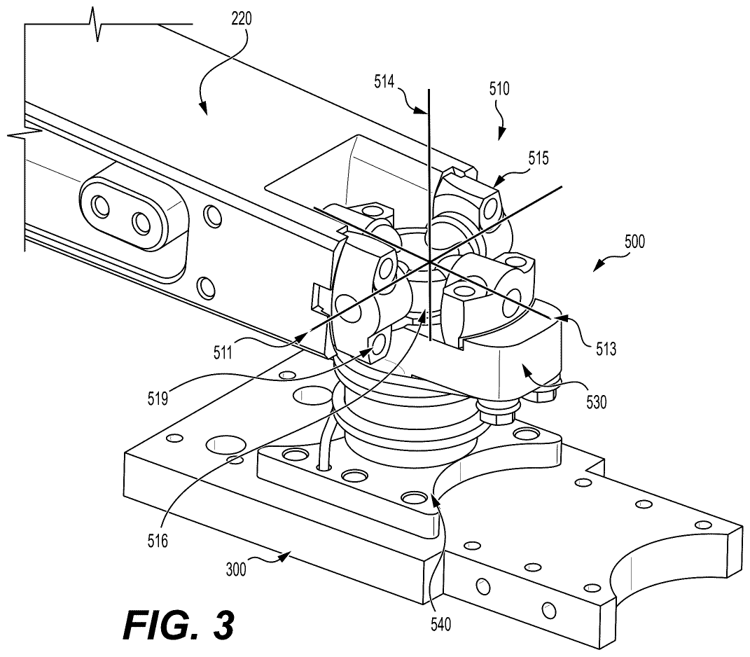

FIG. 3 is a perspective view of the rotational mount assembly 500, according to some embodiments. As FIG. 3 illustrates, the rotational mount assembly 500 may connect the distal end of the trailing arm assembly 220 to the contactor assembly 300. FIG. 3 shows the rotational mount assembly 500 connected to a portion of the contactor assembly 300. In some embodiments, the rotational mount assembly 500 is connected to the stepped central section of the contactor assembly 300, shown in FIG. 2 for example. In some embodiments, as described above, the contactor assembly 300 has a generally flat top surface, which is connected to the rotational mount assembly 500. As further discussed, the rotational mount assembly 500 may maintain contact between the conducting terminals 320 of the contactor assembly 300 and the elevated conductor rails 122 of the electricity-conducting rail system 120, as the mobile machine 140 moves along the ground surface 10 of the job site.

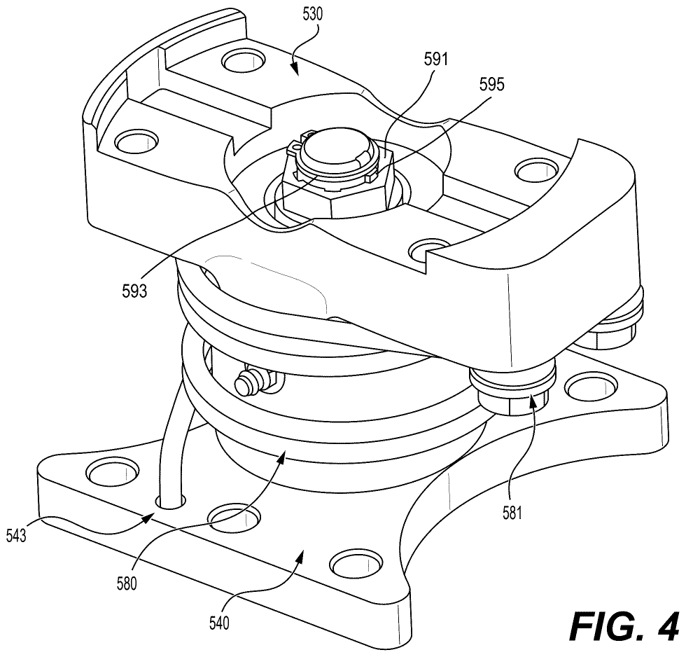

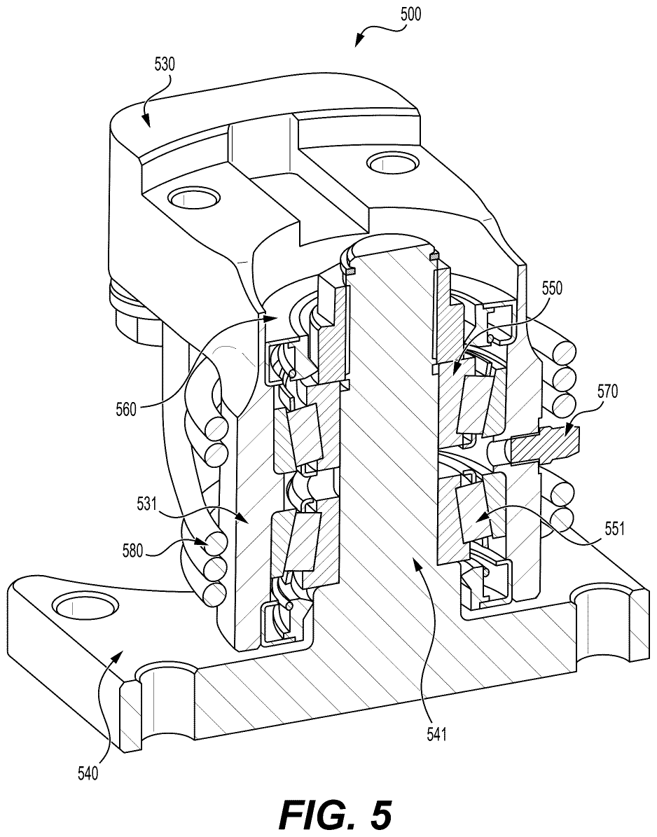

As FIG. 3 illustrates, the rotational mount assembly 500 may include a universal joint 510, a joint bracket 530, and a contactor assembly bracket 540, among other components, as further described below. FIG. 4 is a perspective view of the joint bracket 530 and the contactor assembly bracket 540, and FIG. 5 is a cross-sectional view of the joint bracket 530 and the contactor assembly bracket 540, according to some embodiments. As further described herein, the rotational mount assembly 500 may rotate about three (3) axes—for example, about a pitch axis 511, about a roll axis 513, and about a yaw axis 514, where the axes are substantially perpendicular to one another. Accordingly, the rotational mount assembly 500 may permit rotation of the contactor assembly 300 relative to the trailing arm assembly 220 about those three axes—the pitch axis 511, the roll axis 513, and the yaw axis 514

As FIGS. 3-5 show, the universal joint 510 may include a plurality of connectors 515, through which the universal joint 510 connects to the trailing arm assembly 220 and the joint bracket 530, and each of the connectors 515 may rotate relative to a central portion 516 of the universal joint 510. As FIGS. 3-5 illustrate, in some instance, the universal joint 510 may include four (4) connector 515—two (2) of the connectors 515 connected to the trailing arm assembly 220, and rotatable about the pitch axis 511, and two (2) of the connectors 515 connected to the joint bracket 530, and rotatable about the roll axis 513.

In some instance, the connectors 515 may connect to the trailing arm assembly 220 and the joint bracket 530 by a plurality of bolts (not shown). Thus, with reference to FIG. 3, each of the connectors 515 may include one or more bolt holes 519 through which bolts extend. In some instances, each of the connectors 515 may include two (2) bolt holes 519 to receive two (2) bolts. In some instances, four (4) bolts may connect two (2) of the connectors 515 to the trailing arm assembly 220, and four (4) bolts may connect two (2) of the connectors 515 to the joint bracket 530, each of the bolts extending through the bolt holes 519 of the connectors 515 as well as through corresponding bolt holes in the trailing arm assembly 220 and the joint bracket 530. Once so connected, the universal joint 510 may permit rotation of the joint bracket 530 and the contactor assembly bracket 540, for example, relative to the trailing arm assembly 220, about the pitch axis 511 and about the roll axis 513. Due to the size, shape, orientation, or geometry of certain components, such as the trailing arm assembly 220, the universal joint 510, or the joint bracket 530, among other components, rotation of the joint bracket 530 about the roll axis 513 may be limited to about 10 degrees, about 15 degrees, about 20 degrees, about 25 degrees, or about 30 degrees total. In some instances, the universal joint 510 may be a 5C universal joint.

With reference to the figures, particularly FIGS. 4 and 5, the contactor assembly bracket 540 may include a central shaft 541, and the joint bracket 530 may include a sleeve 531. The sleeve 531 of the joint bracket 530 may surround and may be spaced apart from the central shaft 541 of the contactor assembly bracket 540. As shown, the rotational mount assembly 500 may include two (2) bearing assemblies 550, permitting rotation of the joint bracket 530 relative to the contactor assembly bracket 540, as further described. Each of the bearing assemblies 550 may include a plurality of tapered roller bearings 551. The disposition of the two (2) bearing assemblies 550, which include tapered roller bearings 551 oriented as shown, may allow the rotational mount assembly 500 to support both an axial load and a radial load relative to the central shaft 541 of the contactor assembly bracket 540. As the figures show, a profile of an inner wall of the sleeve 531 may be contoured (e.g., may include a channel, groove, etc.) to locate the bearing assemblies 550 along the central shaft 541 of the contactor assembly bracket 540.

As FIGS. 4 and 5 illustrate, the rotational mount assembly 500 may include two (2) seals 560, which define and close an interior volume between the joint bracket 530 and the contactor assembly bracket 540. As the figures show, the profile of the inner wall of the sleeve 531 may be contoured (e.g., may include a channel, groove, etc.) to locate the seals 560 along the central shaft 541 of the contactor assembly bracket 540. In some instances, the interior volume between the two (2) seals 560 is filled (partially or fully) or supplied with a lubricant, such as a liquid lubricant (e.g., oil), or a semi-solid or solid lubricant (e.g., grease). In some instances, the seals 560 may be wiper seals. The rotational mount assembly 500 may include a fitting 570, through which the interior volume is filled with the lubricant. In some instances, the fitting 570 may be a Zerk fitting, grease fitting, or another fitting.

As FIGS. 3-5 illustrate, the rotational mount assembly 500 may include two torsional springs 580. The torsional springs 580 may be wound in opposite directions relative to one another, around the sleeve 531 of the joint bracket 530. By this arrangement, when the contactor assembly bracket 540 is rotated about the yaw axis 514 relative to the joint bracket 530 in a first direction (e.g., clockwise, as viewed from a top surface of the joint bracket 530 in FIG. 4), one of the two torsional springs 580 extends and thereby both opposes the rotation and urges the contactor assembly bracket 540 in a second direction opposite the first direction (e.g., urges the contactor assembly bracket 540 in a counterclockwise direction); and when the contactor assembly bracket 540 is rotated about the yaw axis 514 relative to the joint bracket 530 in the second direction (e.g., counterclockwise), the other one of the two torsional springs 580 extends and thereby opposes the rotation and urges the contactor assembly bracket 540 in the first direction (e.g., urges the contactor assembly bracket 540 in the clockwise direction). Restated, due to the opposite direction of winding, the torsional springs 580 may be oppositely biased. As the figures show, one end or a first end of each torsional spring 580 may connect to the joint bracket 530, and an opposite end or a second end of each torsional spring 580 may connect to the contactor assembly bracket 540. As the figures show, in some instances, the first end of each torsional spring 580 may connect to the joint bracket 530 by a bolt 581 extending through a bolt hole in the joint bracket 530, and the second end of each of the torsional springs 580 may be positioned within a spring opening 543 in the contactor assembly bracket 540. In some instances, however, the first and second ends of the torsional springs 580 may connect to the joint bracket 530 or the contactor assembly bracket 540 in another manner—for example, bolts may connect both the first and second ends of the torsional springs 580 to the joint bracket 530 and the contactor assembly bracket 540, or both the first and second ends of the torsional springs 580 may be positioned within spring openings in the joint bracket 530 and the contactor assembly bracket 540. Properties of the torsional springs 580 may be selected such that rotation of the contactor assembly bracket 540, relative to the joint bracket 530, about the yaw axis 514 may be limited to about 45 degrees, about 60 degrees, about 75 degrees, about 90 degrees, or about 120 degrees total. Although the figures show torsional springs 580, one or more other springs may be used in place of or in addition to the torsional springs 590. For example, in some instances, one or more extension springs may be used.

As FIGS. 3-5 illustrate, the rotational mount assembly 500 may include a nut 591, disposed on a threaded portion of the central shaft 541 of the contactor assembly bracket 540. The nut 591 may secure the components in the rotational mount assembly 500, and may prevent the flow of the lubricant out of the interior volume described above. In some instances, the nut 591 may preload or apply an axial load to the bearing assemblies 550, through an interaction of the bearing assemblies 550 and the profile of the inner wall of the sleeve 531. As FIGS. 4 and 5 illustrate, the rotational mount assembly 500 may further include a snap ring 593, disposed within a channel in the central shaft 541, the snap ring 593 including a tab 595 disposed within a corresponding notch in the nut 591. By this arrangement, the snap ring 593 may prevent loosening of the nut 591 on the threaded portion of the central shaft 541.

As FIGS. 3-5 illustrate, the contactor assembly bracket 540 may include one or more bolt holes through which bolts may extend. In some instances, the rotational mount assembly 500 may include two (2), four (4), six (6), eight (8), ten (10), or more than ten (10) bolt holes, and a corresponding number of bolts may extend through the bolt holes in the contactor assembly bracket 540 as well as through corresponding number of bolt holes in the contactor assembly 300.

### INDUSTRIAL APPLICABILITY

The disclosed aspects of the rotational mount assembly 500 of the present disclosure may provide numerous advantages. For example, the rotational mount assembly 500 allows for rotation of the contactor assembly 300, relative to the trailing arm assembly 220, about three (3) axes—the pitch axis 511, the roll axis 513, and the yaw axis 514. Thus, a single, compact assembly—the rotational mount assembly 500—allows for rotation of the contactor assembly in three (3) degrees of freedom. Therefore, connecting the contactor assembly 300 to the trailing arm assembly 220 with the rotational mount assembly 500 allows the contactor assembly 300 effectively to remain in contact with the elevated conductor rails 122. In contrast, for example, the use of a conventional ball-and-socket joint may provide a more limited range of rotation than provided by the rotational mount assembly 500, and may not allow a contactor assembly to remain in contact with elevated conductor rails.

Further, the rotational mount assembly 500 includes torsional springs 580, one which permits but biases against rotation in a first direction (e.g., clockwise) about the yaw axis, and the other which permits but biases against rotation in a second, opposite direction (e.g., counterclockwise) about the yaw axis. As a result, the rotational mount assembly 500 permits rotation of the contactor assembly 300 relative to the trailing arm assembly 220 about the yaw axis, such that the contactor assembly 300 may remain in contact with the elevated conductor rails 122, while still biasing the contactor assembly 300 to a central or neutral position.

As shown and described, in some instances, the rotational mount assembly 500 includes bearing assemblies 550. Using bearing assemblies 550 provides an increased lifetime for the rotational mount assembly 500, as compared to components or assemblies that do not include bearings between rotating components, such as the conventional ball-and-socket joint. Further, using bearing assemblies 550 including tapered roller bearings 551 effectively supports both axial and radial loads on the rotational mount assembly 500.

Although the disclosure and the figures describe and illustrate the rotational mount assembly 500 between the trailing arm assembly 220 and the contactor assembly 300 of a mobile machine 140, the rotational mount assembly 500 is not limited to use in the mobile machine power system 100, and is not limited to use with any particular type of mobile machine 140.

It will be apparent to those skilled in the art that various modifications and variations may be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A rotational mount assembly for connecting a contactor assembly to an arm assembly, the rotational mount assembly comprising:
a joint comprising a first connector and a second connector, the first connector being configured to connect to the arm assembly, wherein the first connector is configured to rotate about a first axis, the second connector is configured to rotate about a second axis, and the first axis is substantially perpendicular to the second axis;
a joint bracket connected to the second connector of the joint, the joint bracket including a sleeve; and
a contactor assembly bracket configured to connect to the contactor assembly, the contactor assembly bracket including a shaft, wherein the sleeve of the joint bracket surrounds the shaft of the contactor assembly bracket, the contactor assembly bracket is configured to rotate about a third axis, and the third axis is substantially perpendicular to the first axis and the second axis.

2. The rotational mount assembly of claim 1, further comprising:
at least one torsional spring, wherein the at least one torsional spring allows but opposes rotation in a first direction about the third axis.

3. The rotational mount assembly of claim 1, further comprising:
first and second torsional springs, wherein the first torsional spring allows but opposes rotation in a first direction about the third axis, and the second torsional spring allows but opposes rotation in a second direction about the third axis, wherein the second direction is opposite the first direction.

4. The rotational mount assembly of claim 1, further comprising:
at least one bearing assembly between the sleeve of the joint bracket and the shaft of the contactor assembly bracket.

5. The rotational mount assembly of claim 1, further comprising:
first and second bearing assemblies, the first and second bearing assemblies being between the sleeve of the joint bracket and the shaft of the contactor assembly bracket.

6. The rotational mount assembly of claim 1, further comprising:
a fastener on a threaded end portion of the shaft of the contactor assembly bracket.

7. The rotational mount assembly of claim 1, wherein the joint is a universal joint.

8. The rotational mount assembly of claim 1, wherein the first axis is a pitch axis, the second axis is a roll axis, and the third axis is a yaw axis.

9. A mobile machine, comprising:
a frame;
an arm connected to the frame;
a contactor configured to receive electricity from a rail; and
a rotational mount connecting the arm to the contactor, the rotational mount comprising:
a joint comprising a first connector and a second connector, the first connector being connected to the arm, wherein the first connector is configured to rotate about a first axis, and the second connector is configured to rotate about a second axis;
a joint bracket connected to the second connector of the joint, the joint bracket including a sleeve; and
a contactor bracket connected to the contactor, the contactor bracket including a shaft, wherein the sleeve of the joint bracket surrounds the shaft of the contactor bracket, and the contactor bracket is configured to rotate about a third axis.

10. The mobile machine of claim 9, wherein the rotational mount further comprises:
at least one spring, wherein the at least one spring allows but opposes rotation in a first direction about the third axis.

11. The mobile machine of claim 9, wherein the rotational mount further comprises:
first and second springs, wherein the first spring allows but opposes rotation in a first direction about the third axis, and the second spring allows but opposes rotation in a second direction about the third axis.

12. The mobile machine of claim 9, wherein the rotational mount further comprises:
at least one bearing between the sleeve of the joint bracket and the shaft of the contactor bracket.

13. The mobile machine of claim 9, wherein the rotational mount further comprises:
first and second bearings, the first and second bearings between the sleeve of the joint bracket and the shaft of the contactor bracket.

14. The mobile machine of claim 9, wherein the rotational mount further comprises:
a fastener on a threaded end portion of the shaft of the contactor bracket.

15. The mobile machine of claim 9, wherein the joint is a universal joint.

16. The mobile machine of claim 9, wherein the first axis is a pitch axis, the second axis is a roll axis, and the third axis is a yaw axis.

17. A mount assembly for connecting a rotating component to an arm, the mount assembly comprising:
a joint comprising a first connector and a second connector, the first connector being configured to connect to the arm, wherein the first connector is configured to rotate about a first axis, the second connector is configured to rotate about a second axis, and the first axis is substantially perpendicular to the second axis;
a joint bracket connected to the second connector of the joint, the joint bracket including a sleeve;
a component bracket configured to connect to the rotating component, the component bracket including a shaft, wherein the sleeve of the joint bracket surrounds the shaft of the component bracket, the component bracket is configured to rotate about a third axis, and the third axis is substantially perpendicular to the first axis and the second axis; and
first and second springs, wherein the first spring allows but opposes rotation in a clockwise direction about the third axis, and the second spring allows but opposes rotation in a counterclockwise direction about the third axis.

18. The mount assembly of claim 17, further comprising:
at least one bearing assembly between the sleeve of the joint bracket and the shaft of the component bracket,
wherein the at least one bearing assembly includes at least one tapered bearing.

19. The mount assembly of claim 17, wherein at least one of the first and second springs comprises a torsional spring or an extension spring.

20. The mount assembly of claim 17, wherein the first axis is a pitch axis, the second axis is a roll axis, and the third axis is a yaw axis.
